(19) United States
(12) Patent Application Publication
(10) Pub. No.: US 2024/0205754 A1
(43) Pub. Date: Jun. 20, 2024

(54) TECHNIQUES FOR HANDLING VOICE OVER SERVICE FALLBACK

(71) Applicant: QUALCOMM Incorporated, San Diego, CA (US)

(72) Inventors: Sanjay KUMAR, Hyderabad (IN); Bapineedu Chowdary GUMMADI, Hyderabad (IN); Jianqiang ZHANG, Beijing (CN); Swathi SESHADRI, San Diego, CA (US)

(21) Appl. No.: 18/285,760

(22) PCT Filed: Jun. 13, 2021
(86) PCT No.: PCT/CN2021/099916

§ 371 Date: Oct. 5, 2023

(51) Int. Cl. H04W 36/00

(52) U.S. Cl. CPC H04W 36/0022; H04W 36/0079

(57) ABSTRACT

Apparatus, methods, and computer-readable media for facilitating handling of voice over service fallback are disclosed herein. An example method for wireless communication at a UE includes initiating a TAU procedure when performing a change from a first cell associated with a first RAT to connect to a second cell associated with a second RAT different than the first RAT. The example method also includes initiating a timer when the TAU procedure fails, the timer associated with a first duration. The example method also includes re-initiating the TAU procedure based on an occurrence of a timer modification event, the re-initiating of the TAU procedure occurring before the first duration associated with the timer expires.

### BACKGROUND

### Technical Field

The present disclosure relates generally to communication systems, and more particularly, to wireless communication including voice over long term evolution (VOLTE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication of a user equipment (UE). An example apparatus initiates a tracking area update (TAU) procedure when performing a change from a first cell associated with a first radio access technology (RAT) to connect to a second cell associated with a second RAT different than the first RAT. The example apparatus also initiates a timer when the TAU procedure fails, the timer associated with a first duration. Additionally, the example apparatus re-initiates the TAU procedure based on an occurrence of a timer modification event, the re-initiating of the TAU procedure occurring before the first duration associated with the timer expires.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and a UE in an access network.

FIG. 4 is an example communication flow between a base station and a UE, in accordance with the teachings disclosed herein.

FIG. 5 is a flowchart of a method of wireless communication at a UE, in accordance with the teachings disclosed herein.

FIG. 6 is a flowchart of a method of wireless communication at a UE, in accordance with the teachings disclosed herein.

FIG. 7 is a flowchart of a method of wireless communication at a UE, in accordance with the teachings disclosed herein.

FIG. 8 is a diagram illustrating an example of a hardware implementation for an example apparatus, in accordance with the teachings disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

Any number of wireless networks may be deployed in a given geographic area. Each wireless network may support a particular radio access technology (RAT) and may operate on one or more frequencies. In some examples, a RAT may not support voice over in which a voice over service is transmitted over the RAT. Examples of a voice over services include voice over LTE (VOLTE) calls, voice over NR (VONR) calls, and video telephony (VT) calls. To support voice over service on such a RAT, a UE and the RAT may support a fallback procedure in which the UE falls back to a second RAT for voice over service.

For example, a UE may be in communication with and camped on a first cell associated with a first RAT, such as 5G NR, when the UE initiates a voice over call. If the first cell is unable to support the voice over service (e.g., a voice over NR or “VoNR” call), then the initiating of the voice over call by the UE will trigger a VOLTE call. The first cell may then redirect the UE to a cell that is capable of supporting the voice over service. For example, the first cell may instruct (or trigger) the UE to perform a redirection procedure to establish a connection with a second cell associated with a second RAT, such as LTE. In some examples, based on performing the redirection to the second cell, the UE may initiate a tracking area update (TAU) procedure. The TAU procedure may facilitate the network with maintaining information about the location of the UE. However, as the redirection procedure may be a blind redirection, it may be possible that the UE is unable to camp on the second cell to which the UE is redirected and, thus, the TAU procedure may fail. For example, the UE may experience radio link failure (RLF) due to poor signal conditions. In some such examples, it may be beneficial for the UE to search for another suitable cell. However, when the TAU procedure fails, the UE may initiate a timer (e.g., a T3411 timer). In some such examples, the UE may be unable to initiate performing another TAU procedure while the timer is active.

In some examples, the duration of the T3411 timer may be relatively long. As a result, if the UE is unable to establish a connection with a cell that provides the UE with suitable signal quality, the UE may experience call failure. For example, when the UE initiates the VOLTE call, a Quality of Service (QOS) timer may be initiated. The QoS timer may correspond to an IP Multimedia Subsystem (IMS) timer during which the UE is waiting to receive a dedicated voice packet from the network. The duration of the QoS timer may be less than the T3411 timer. If the UE is unable to establish a dedicated bearer with the network for receiving the voice packet before the T3411 timer expires, the UE may experience call failure.

However, in some examples, while the T3411 timer is active, conditions at the UE may change. For example, the signal quality of the current cell may improve. In other examples, the UE may perform a cell reselection procedure to establish a connection with another cell associated with the second RAT (e.g., LTE).

Aspects disclosed herein provide techniques for the UE to adjust the handling of the T3411 timer to improve the UE performance and call quality. For example, aspects disclosed herein enable the UE to reduce the T3411 timer duration or to ignore the T3411 timer if conditions at the UE change. In some examples, the UE may monitor for a timer modification event after initiating the T3411 timer. Examples of a timer modification event include an improved signal quality of a current cell. In some examples, the timer modification event may occur when the signal quality of the current cell satisfies (e.g., is greater than or equal to) a quality threshold. In other examples, the timer modification event may occur when the UE performs a cell reselection procedure and establishes a connection with another cell. In examples in which the UE detects the occurrence of a timer modification event, the UE may perform another TAU procedure without waiting for the T3411 timer to expire. That is, the occurrence of the timer modification event may trigger the UE to immediately re-initiate performing the TAU procedure. As the timer modification event is associated with an improved signal quality, the performing of the TAU procedure may be successful, which may reduce occurrences of call failures and, thus, improve call performance.

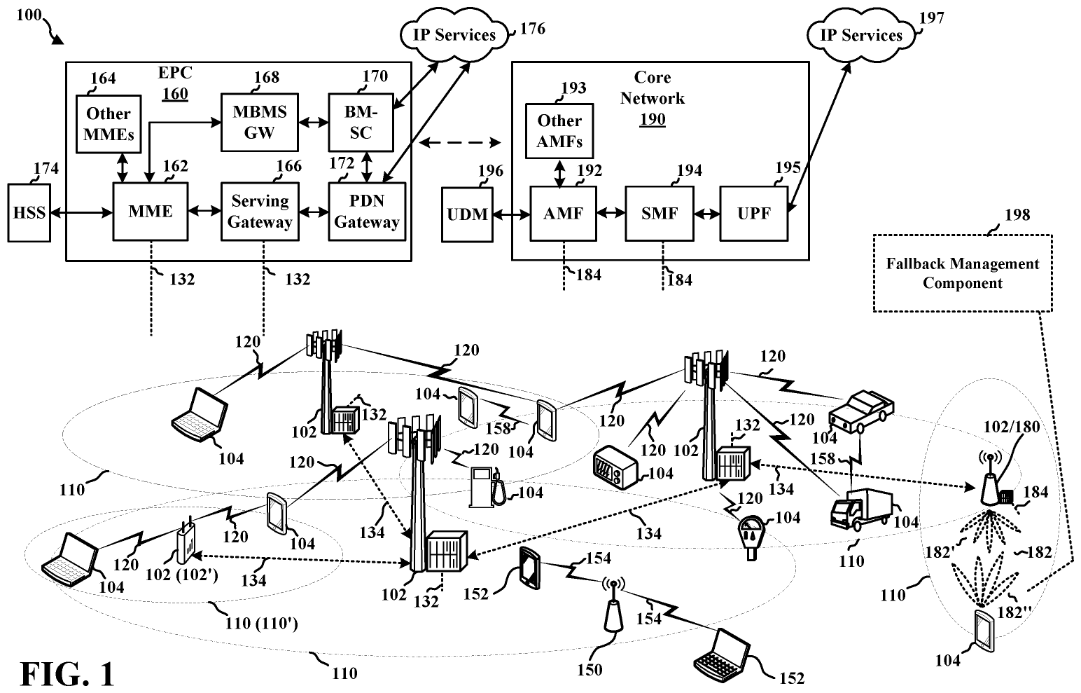

FIG. 1 is a diagram illustrating an example of a wireless communications system and an access network 100 including base stations 102 and 180 and UEs 104. In certain aspects, a device in communication with a base station, such as a UE 104, may be configured to manage one or more aspects of wireless communication by facilitating the performing of a fallback procedure to maintain a voice over call. For example, the UE 104 may include a fallback management component 198 configured to handle a VOLTE call while performing a fallback. In certain aspects, the fallback management component 198 may be configured to initiate a TAU procedure when performing a change from a first cell associated with a first RAT to connect to a second cell associated with a second RAT different than the first RAT. The example fallback management component 198 may also be configured to initiate a timer when the TAU procedure fails, the timer associated with a first duration. Additionally, the example fallback management component 198 may be configured to re-initiate the TAU procedure based on an occurrence of a timer modification event, the re-initiating of the TAU procedure occurring before the first duration associated with the timer expires.

Although the following description provides examples directed to VOLTE calls, the concepts described herein may be applicable to other similar areas, such as Voice NR (VoNR) calls and video telephony (VT) calls, and/or other wireless technology services, in which IP packets are used.

Additionally, while the following description provides examples directed to 5G NR, the concepts described herein may be applicable to other similar areas, such as LTE, LTE-A, CDMA, GSM, and/or other wireless technologies, in which a UE may handle a VOLTE call while performing a fallback procedure.

The example of the wireless communications system of FIG. 1 (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

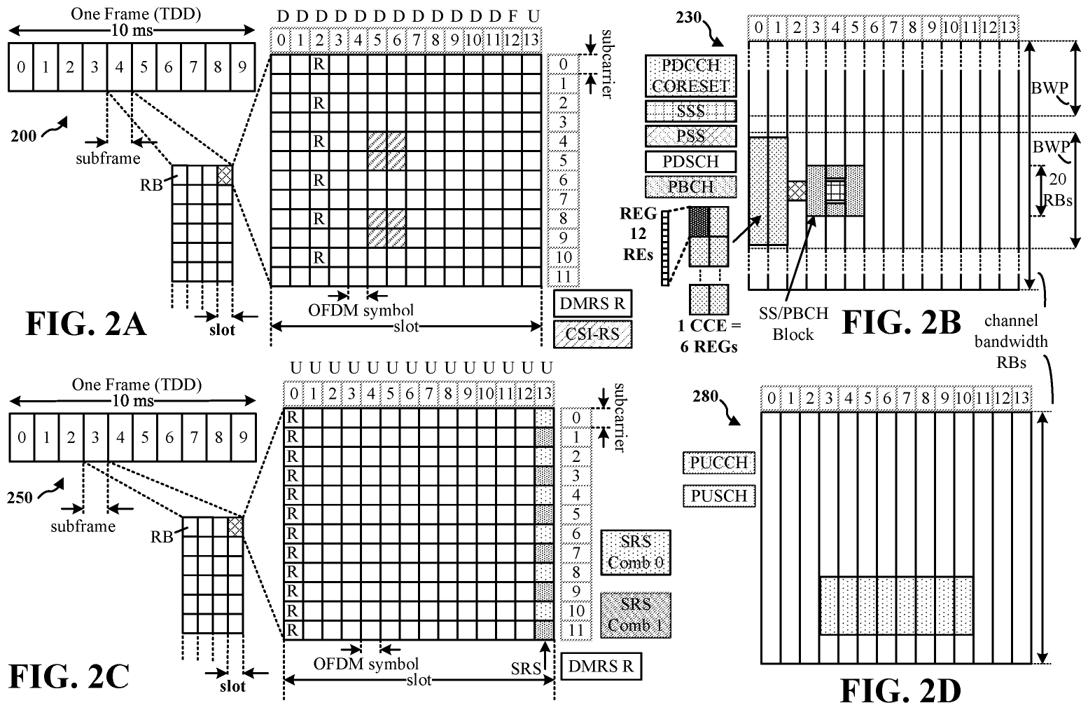

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

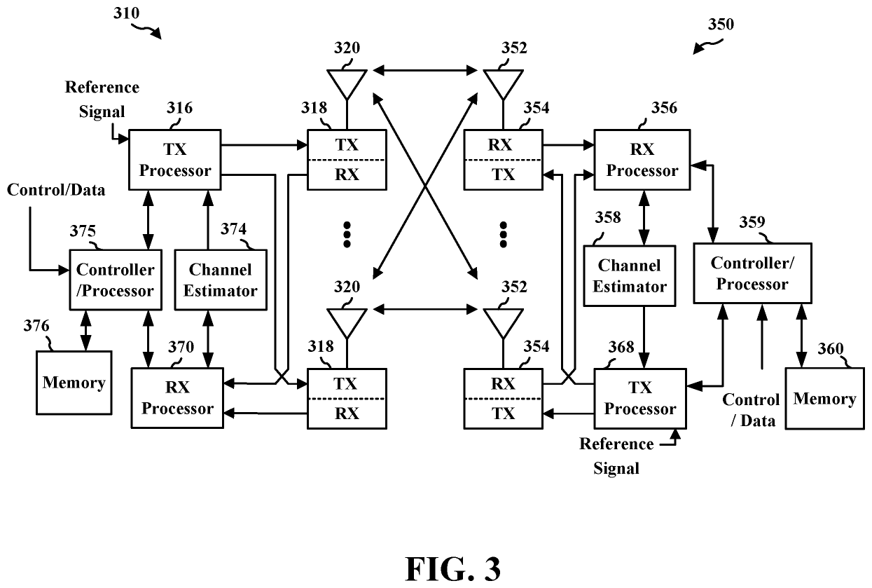

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor (e.g., a TX processor 316) and the receive (RX) processor (e.g., an RX processor 370) implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to an RX processor 356. A TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by a channel estimator 358. The soft decisions are then decoded and deinterleaved to recover the data and control signals that were originally transmitted by the base station 310 on the physical channel. The data and control signals are then provided to a controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to the RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the fallback management component 198 of FIG. 1.

Any number of wireless networks may be deployed in a given geographic area. Each wireless network may support a particular RAT and may operate on one or more frequencies. In some examples, a RAT may not support voice over in which a voice over service is transmitted over the RAT. To support voice over service on such a RAT, a UE and the RAT may support a fallback procedure in which the UE falls back to a second RAT for voice over service.

For example, a UE may be in communication with and camped on a first cell associated with a first RAT, such as 5G NR, when the UE initiates a voice over call. If the first cell is unable to support the voice over service (e.g., a voice over NR or “VONR” call), then the initiating of the voice over call by the UE will trigger a VOLTE call. The first cell may then direct the UE to a cell that is capable of supporting the voice over service. For example, the first cell may instruct (or trigger) the UE to perform a redirection procedure to establish a connection with a second cell associated with a second RAT, such as LTE. In the example in which the UE falls back from 5G NR to LTE, the UE may perform an Evolved Packet System (EPS) fallback. In some examples, based on performing the redirection to the second cell, the UE may initiate a tracking area update (TAU) procedure. The TAU procedure may facilitate the network with maintaining information about the location of the UE. However, as the redirection procedure may be a blind redirection, it may be possible that the UE is unable to camp on the second cell to which the UE is redirected and, thus, the TAU procedure may fail. For example, the UE may experience radio link failure (RLF) due to poor signal conditions. In some such examples, it may be beneficial for the UE to search for another suitable cell. However, when the TAU procedure fails, the UE may initiate a timer (e.g., a T3411 timer). In some such examples, the UE may be unable to initiate performing another TAU procedure while the timer is active.

In some examples, the duration of the T3411 timer may be relatively long. As a result, if the UE is unable to establish a connection with a cell that provides the UE with suitable signal quality, the UE may experience call failure. For example, when the UE initiates the VOLTE call, a Quality of Service (QOS) timer may be initiated. The QoS timer may correspond to an IP Multimedia Subsystem (IMS) timer during which the UE is waiting to receive a dedicated voice packet from the network. The duration of the QoS timer may be less than the T3411 timer. If the UE is unable to establish a dedicated bearer with the network for receiving the voice packet before the T3411 timer expires, the UE may experience call failure.

However, in some examples, while the T3411 timer is active, conditions at the UE may change. For example, the signal quality of the current cell may improve. In other examples, the UE may perform a cell reselection procedure to establish a connection with another cell associated with the second RAT (e.g., LTE).

Aspects disclosed herein provide techniques for the UE to adjust the handling of the T3411 timer to improve the UE performance and call quality. For example, aspects disclosed herein enable the UE to reduce the T3411 timer duration or to ignore the T3411 timer if conditions at the UE change. In some examples, the UE may monitor for a timer modification event after initiating the T3411 timer. Examples of a timer modification event include an improved signal quality of a current cell. In some examples, the timer modification event may occur when the signal quality of the current cell satisfies (e.g., is greater than or equal to) a quality threshold. In other examples, the timer modification event may occur when the UE performs a cell reselection procedure and establishes a connection with another cell. In examples in which the UE detects the occurrence of a timer modification event, the UE may perform another TAU procedure without waiting for the T3411 timer to expire. That is, the occurrence of the timer modification event may trigger the UE to immediately re-initiate performing the TAU procedure. As the timer modification event is associated with an improved signal quality, the performing of the TAU procedure may be successful, which may reduce occurrences of call failures and, thus, improve call performance.

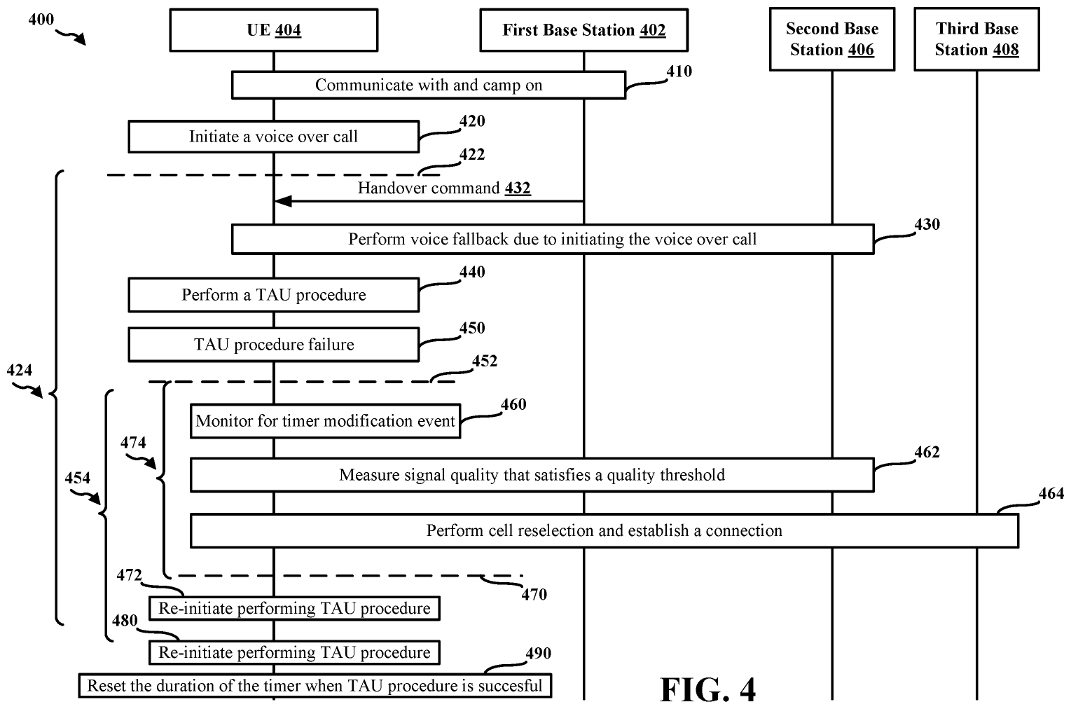

FIG. 4 illustrates an example communication flow 400 between a UE 404, a first base station 402, and a second base station 406, as presented herein. In the illustrated example, the communication flow 400 facilitates the UE 404 handling a VOLTE call while performing a voice fallback. Aspects of the base stations 402, 406 may be implemented by the base station 102/180 of FIG. 1 and/or the base station 310 of FIG. 3. Aspects of the UE 404 may be implemented by the UE 104 of FIG. 1 and/or the UE 350 of FIG. 3. Although not shown in the illustrated example of FIG. 4, it may be appreciated that in additional or alternative examples, one or both of the base stations 402, 406 may be in communication with one or more other base stations or UEs, and/or the UE 404 may be in communication with one or more other base stations or UEs.

At 410, the UE 404 is communicating with and camping on the first base station 402. The first base station 402 may provide communication coverage for a particular geographic area (e.g., a “cell”). In the illustrated example of FIG. 4, the first base station 402 may provide a first cell that is associated with a first RAT, such as 5G NR.

At 420, the UE 404 initiates performing a voice over call while camping on the first base station 402. For example, the UE 404 may initiate performing a VOLTE call or a video telephony call. As shown in FIG. 4, the UE 404 may initiate a QoS Timer 422 after initiating the voice over call. The QoS timer 422 may be associated with a first duration 424. The QoS timer 422 may correspond to a period during which the UE 404 is waiting to establish a dedicated bearer to facilitate the voice over call. If the UE 404 is unable to establish a dedicated bearer to facilitate the voice over call before the QoS timer 422 expires (e.g., at the end of the first duration 424), then the UE 404 may experience a call failure.

At 430, the UE 404 performs a voice fallback due to initiating the voice over call. For example, the UE 404 may perform a handover procedure from the first base station 402 to the second base station 406. The second base station 406 may provide a second cell that is associated with a second RAT, such as LTE.

In some examples, the first base station 402 may transmit a handover command 432 directing the UE 404 from the first base station 402 to the second base station 406 in response to the voice over call initiation. The handover command may include a handover command, a re-direction command (e.g., a blind redirection), or any other command that directs the UE 404 from the first base station 402 to the second base station 406.

At 440, the UE 404 performs a TAU procedure with the second base station 406. For example, the UE 404 may transmit a TAU request to the second base station 406 to second base station 406 to register with the second base station 406. The TAU procedure may enable the second base station 406 to track the location of the UE 404 (e.g., within the second cell provided by the second base station 406).

In the illustrated example of FIG. 4, at 450, the TAU procedure fails. The TAU procedure may fail due to poor signal conditions. For example, the UE 404 and the second base station 406 may be unable to successfully perform a random access channel (RACH) procedure to establish a connection.

As shown in FIG. 4, the UE 404 may initiate a timer 452 (e.g., a T3411 timer) when the TAU procedure fails (e.g., at 450). The timer 452 may be associated with a second duration 454 (e.g., ten seconds). The timer 452 may correspond to an EPS mobility management timer and indicate a period during which the UE 404 waits to perform another TAU procedure. For example, after the timer 452 expires (e.g., at the end of the second duration 454), the UE 404 may re-initiate, at 480, performing a TAU procedure. As shown in FIG. 4, the timer 452 expires after the QoS timer 422 expires and, thus, if the TAU procedure fails (e.g., at 450), the UE 404 may experience a call failure.

To improve UE performance and call quality, the UE 404 is configured to modify the handling of the timer 452. For example, the UE 404 may reduce the duration associated with the timer 452 (e.g., the second duration 454). By reducing the duration associated with the timer 452, the UE 404 may re-initiate performing a TAU procedure earlier, relative to the start of the QoS timer 422, which may improve occurrences of the TAU procedure successfully completing and the UE 404 establishing a dedicated bearer to perform the voice over call before the QoS timer 422 expires.

In the illustrated example of FIG. 4, at 460, the UE 404 monitors for a timer modification event. Examples of a timer modification event include detecting an improved signal quality. For example, the poor signal quality that caused the TAU procedure failure (e.g., at 450) may be due to an object blocking the signal between the UE 404 and the second base station 406. In some such examples, the signal blockage may be temporary (e.g., due to the UE 404 moving within the second cell and/or the object blocking the signal moving). As a result, the signal quality may improve.

At 462, the UE 404 may measure a signal quality that satisfies a quality threshold (e.g., the measured signal quality is greater than or equal to the quality threshold). The quality threshold may be configured so that the UE 404 is able to establish a connection with a base station when the quality threshold is satisfied. That is, if the measured signal quality satisfies the quality threshold, the UE 404 is also able to successfully complete a TAU procedure and, thus, it may be beneficial for the UE 404 to re-initiate performing the TAU procedure before the timer 452 expires (e.g., at the end of the second duration 454). In such examples (e.g., when the measured signal quality satisfies the quality threshold), the UE 404 may determine the occurrence of a timer modification event and reduce the duration of the timer 452. For example, based on the occurrence of the timer modification event (e.g., at 462), the UE 404 may stop the timer 452, at 470, which may result in the timer 452 being associated with a third duration 474 that is less than the second duration 454.

In some examples, while monitoring for the timer modification event (e.g., at 460), the UE 404 may perform cell reselection and establish a connection with a different cell. For example, the UE 404 may perform cell reselection and select a third base station 408 with which to establish a connection. The third base station 408 may provide a third cell that is associated with the second RAT, such as LTE. The UE 404 may select the third base station 408 based on a signal characteristic associated with the third base station 408. For example, the UE 404 may determine that a signal strength measurement associated with the third base station 408 may satisfy a quality threshold and, thus, select the third base station 408 with which to establish a connection.

At 464, the UE 404 may perform cell reselection and establish a connection with the third base station 408. The UE 404 may establish the connection with the third base station 408 by successfully performing a RACH procedure. When the UE 404 is able to establish a connection with the third base station 408, the UE 404 is also to successfully complete a TAU procedure and, thus, it may be beneficial for the UE 404 to re-initiate performing the TAU procedure before the timer 452 expires (e.g., at the end of the second duration 454). In such examples (e.g., when the UE 404 establishes a connection with the third base station 408 after performing cell reselection), the UE 404 may determine the occurrence of a timer modification event and reduce the duration of the timer 452. For example, based on the occurrence of the timer modification event (e.g., at 464), the UE 404 may stop the timer 452, at 470, which may result in the timer 452 being associated with a third duration 474 that is less than the second duration 454.

At 472, the UE 404 re-initiates performing the TAU procedure based on the occurrence of the timer modification event (e.g., at 462 or 464). As shown in FIG. 4, the UE 404 re-initiates the performing of the TAU procedure (e.g., at 472) before the second duration 454 associated with the timer 452 expires. Additionally, in the example of FIG. 4, the UE 404 may re-initiate the performing of the TAU procedure (e.g., at 472) before the first duration 424 associated with the QoS timer 422 expires. In such examples, the UE 404 may successfully complete the voice over call (e.g., avoid experiencing a call failure).

In some examples, the UE 404 may not detect the occurrence of a timer modification event before the timer 452 expires (e.g., at the end of the second duration 454). In such examples, the UE 404 may re-initiate, at 480, the performing of the TAU procedure. However, as described above, in some such examples, the performing of the TAU procedure (e.g., at 480) may occur after the QoS timer 422 expires and, thus, the voice over call may fail.

In the illustrated example, at 490, the UE 404 resets the duration of the timer 422 after successfully performing the TAU procedure. For example, if the UE 404 detects the occurrence of a timer modification event (e.g., at 462 or 464), the UE 404 may reduce the duration of the timer 452 from the second duration 454 to the third duration 474. In such examples, the UE 404 may reset the duration of the timer 452 from the third duration 474 to the second duration 454 when the TAU procedure is successful.

Although not shown in the example of FIG. 4, it may be appreciated that in some examples, the UE 404 may detect the occurrence of a timer modification event (e.g., at 462 or 464) and re-initiate the performing of the TAU procedure (e.g., at 472), but may fail to successfully complete the TAU procedure. In some such examples, the UE 404 may restart the timer 452 and resume monitoring for a timer modification event (e.g., at 460) until a timer modification event occurs (e.g., at 462 or 464) or the timer 452 expires (e.g., at the end of the second duration 454).

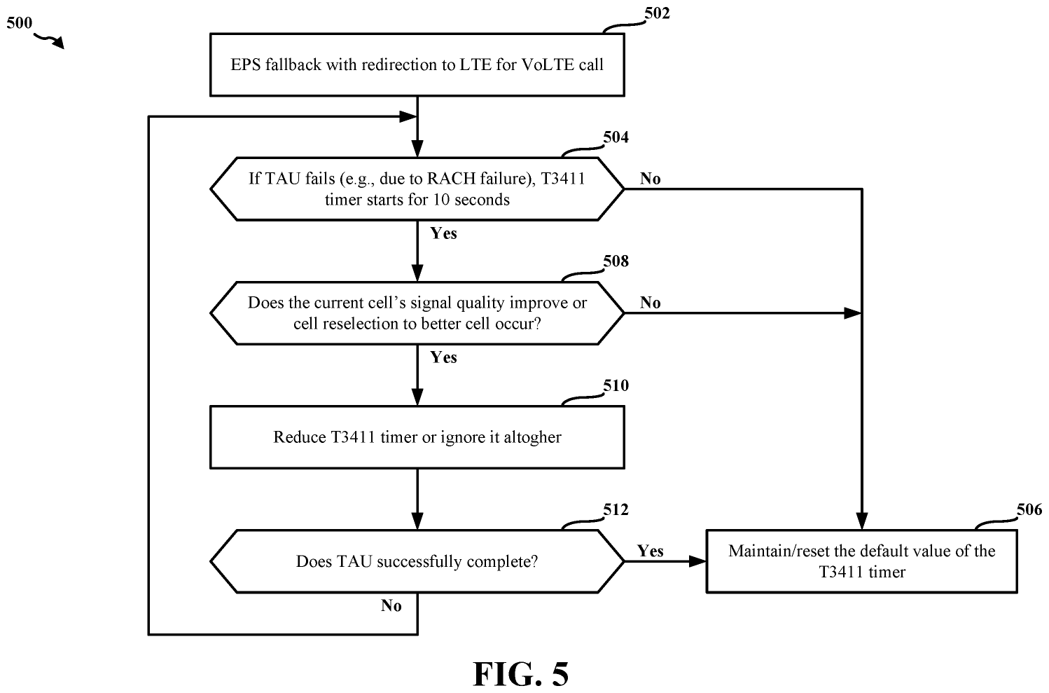

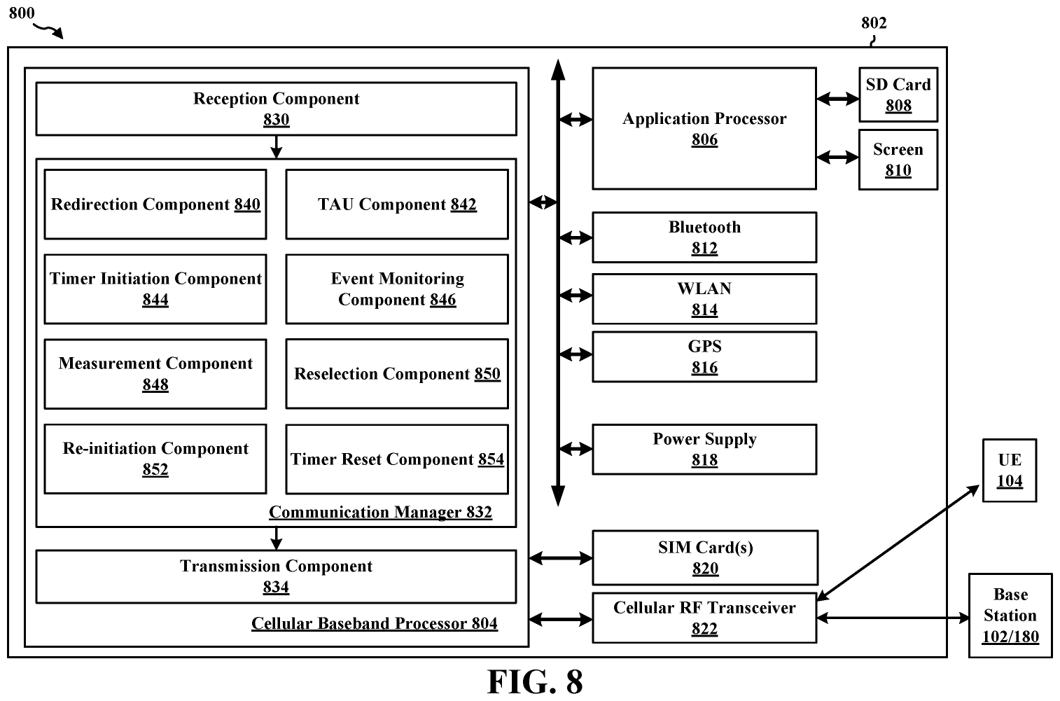

FIG. 5 is a flowchart 500 of a method of wireless communication. The method may be performed by a UE (e.g., the UE 104, the UE 350, and/or an apparatus 802 of FIG. 8). The method may facilitate improving call quality by enabling the UE to modify the duration of the timer (e.g., the T3411 timer) initiated after an unsuccessful TAU procedure.

At 502, the UE performs EPS fallback with redirection to LTE for a VOLTE call. In some examples, the UE may perform a TAU procedure in response to performing the EPS fallback with redirection. The redirection may be a blind redirection.

At 504, the UE determines if TAU failed (e.g., due to a RACH failure) and, if so, the UE starts the T3411 timer. The T3411 may have a duration of 10 seconds.

If, at 504, the UE determines that the TAU did not fail (e.g., the TAU procedure was successful), then, at 506, the UE maintains the default duration of the T3411 timer.

If, at 504, the UE determines that the TAU failed, then, at 508, the UE monitors for a timer modification event. For example, the UE may monitor for an occurrence of a signal quality of a current cell to improve. In some examples, at 508, the UE may monitor for a cell reselection to a better cell to occur.

If, at 508, the UE determines that a timer modification event does not occur (e.g., the signal quality of the current cell does not improve or that a cell reselection to a better cell does not occur), then, at 506, the UE maintains the default duration of the T3411 timer.

If, at 508, the UE determines a timer modification event occurs (e.g., the signal quality of the current cell improved or that a cell reselection to a better cell occurred), then, at 510, the UE reduces the duration of the T3411 timer. In some examples, the UE may ignore the T3411 timer altogether.

At 512, the UE determines whether the TAU is successful. If, at 512, the UE determines that the TAU is successful, then, at 506, the UE maintains (or resets) the default duration of the T3411 timer.

If, at 512, the UE determines that the TAU was unsuccessful, then control returns to 504 and the UE performs a TAU.

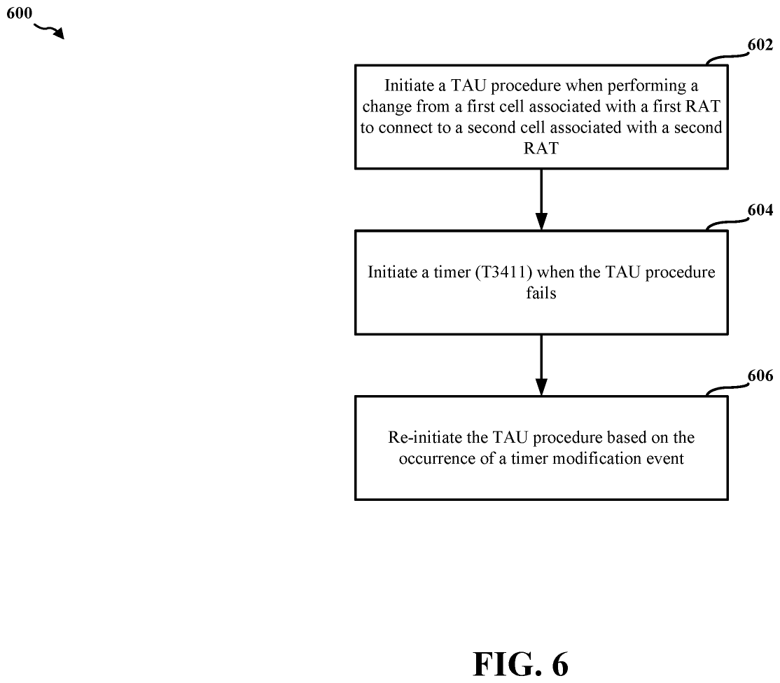

FIG. 6 is a flowchart 600 of a method of wireless communication. The method may be performed by a UE (e.g., the UE 104, the UE 350, and/or an apparatus 802 of FIG. 8). The method may facilitate improving call quality by enabling the UE to modify the duration of the timer (e.g., the T3411 timer) initiated after an unsuccessful TAU procedure.

At 602, the UE initiates a TAU procedure when performing a change from a first cell associated with a first RAT to connect to a second cell associated with a second RAT, as described in connection with 430 of FIG. 4. For example, 602 may be performed by a TAU component 842 of the apparatus 802 of FIG. 8. In some examples, the UE may perform the change from the first cell to the second cell as part of an EPS fallback due to a VoNR call, a VOLTE call, or a video telephony call.

At 604, the UE initiates a timer when the TAU procedure fails, as described in connection with the timer 452 of FIG. 4. For example, 604 may be performed by a timer initiation component 844 of the apparatus 802 of FIG. 8. The timer may be associated with a first duration. In some examples, the timer may correspond to a T3411 timer.

At 606, the UE re-initiates the TAU procedure based on an occurrence of a timer modification event, as described in connection with 472 of FIG. 4. For example, 606 may be performed by a re-initiation component 852 of the apparatus 802 of FIG. 8. The re-initiating of the TAU procedure may occur before the first duration associated with the timer expires.

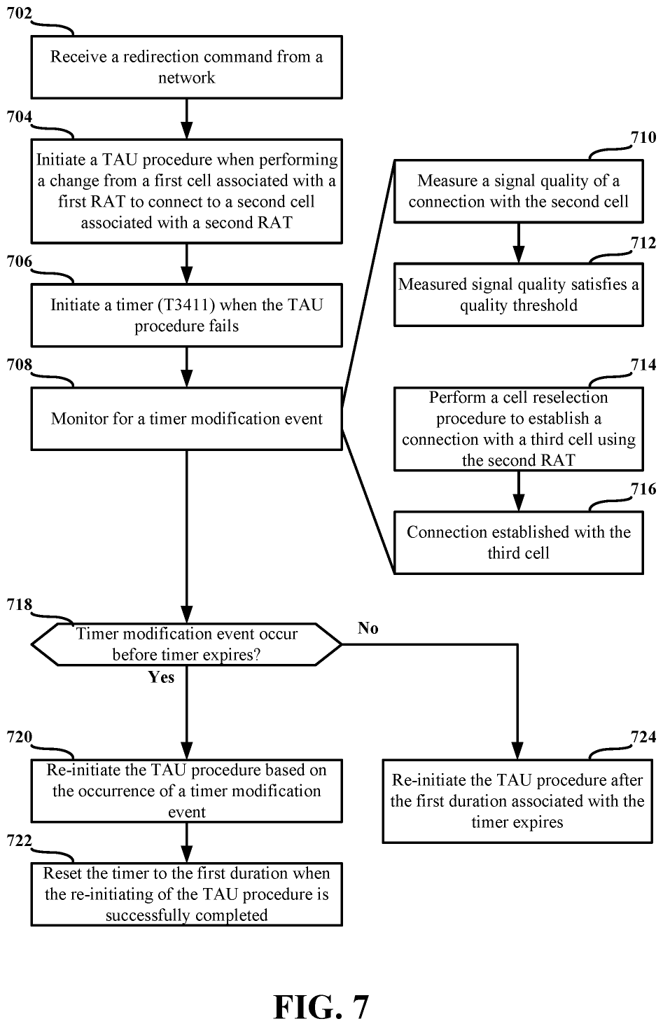

FIG. 7 is a flowchart 700 of a method of wireless communication. The method may be performed by a UE (e.g., the UE 104, the UE 350, and/or an apparatus 802 of FIG. 8). Various implementations may include a method with any combination of the aspects described in connection with FIG. 7. The method may facilitate improving call quality by enabling the UE to modify the duration of the timer (e.g., the T3411 timer) initiated after an unsuccessful TAU procedure.

At 702, the UE may receive a redirection command from a network, as described in connection with the handover command 432 of FIG. 4. For example, 702 may be performed by a redirection component 840 of the apparatus 802 of FIG. 8. In some examples, the redirection command may cause the UE to perform a blind redirection.

At 704, the UE initiates a TAU procedure when performing a change from a first cell associated with a first RAT to connect to a second cell associated with a second RAT, as described in connection with 440 of FIG. 4. For example, 704 may be performed by a TAU component 842 of the apparatus 802 of FIG. 8. In some examples, the UE may perform the change from the first cell to the second cell as part of an EPS fallback due to a VoNR call, a VOLTE call, or a video telephony call.

At 706, the UE initiates a timer when the TAU procedure fails, as described in connection with the timer 452 of FIG. 4. For example, 706 may be performed by a timer initiation component 844 of the apparatus 802 of FIG. 8. The timer may be associated with a first duration. In some examples, the timer may correspond to a T3411 timer.

At 708, the UE may monitor for a timer modification event, as described in connection with 460 of FIG. 4. For example, 708 may be performed by an event monitoring component 846 of the apparatus 802 of FIG. 8.

At 710, the UE may measure a signal quality of a connection with the second cell, as described in connection with 462 of FIG. 4. For example, 710 may be performed by a measurement component 848 of the apparatus 802 of FIG. 8.

At 712, the UE may determine that the measured signal quality satisfies a quality threshold, as described in connection with 462 of FIG. 4. For example, 712 may be performed by the measurement component 848 of the apparatus 802 of FIG. 8.

At 714, the UE may perform a cell reselection to establish a connection with a third cell using the second RAT, as described in connection with 464 of FIG. 4. For example, 714 may be performed by a reselection component 850 of the apparatus 802 of FIG. 8.

At 716, the UE may determine that the connection with the third cell is established, as described in connection with 464 of FIG. 4. For example, 716 may be performed by the reselection component 850 of the apparatus 802 of FIG. 8.

At 718, the UE determines whether a timer modification event occurs before the timer expires, as described in connection with 460, 462, and 464 of FIG. 4. For example, 718 may be performed by the event monitoring component 846 of the apparatus 802 of FIG. 8. In some examples, the timer modification event may occur when a signal quality for the second cell increases. In some examples, the timer modification event occurs when the measured signal quality satisfies a quality threshold (e.g., at 710). In some examples, the timer modification event occurs when the connection is established with the third cell (e.g., at 716).

If, at 718, the UE determines that a timer modification event occurs before the timer expires, then, at 720, the UE re-initiates the TAU procedure based on an occurrence of a timer modification event, as described in connection with 472 of FIG. 4. For example, 720 may be performed by a re-initiation component 852 of the apparatus 802 of FIG. 8. The re-initiating of the TAU procedure may occur before the first duration associated with the timer expires.

At 722, the UE may reset the timer to the first duration when the re-initiating of the TAU procedure is successfully completed, as described in connection with 490 of FIG. 4. For example, 722 may be performed by a timer reset component 854 of the apparatus 802 of FIG. 8.

If, at 718, the UE determines that the timer expires before a timer modification event occurs, then, at 724, the UE may re-initiate the TAU procedure after the first duration associated with the timer expires, as described in connection with 480 of FIG. 4. For example, 724 may be performed by the re-initiation component 852 of the apparatus 802 of FIG. 8.

FIG. 8 is a diagram 800 illustrating an example of a hardware implementation for an apparatus 802. The apparatus 802 may be a UE, a component of a UE, or may implement UE functionality. In some aspects, the apparatus 802 may include a cellular baseband processor 804 (also referred to as a modem) coupled to a cellular RF transceiver 822. In some aspects, the apparatus 802 may further include one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, or a power supply 818. The cellular baseband processor 804 communicates through the cellular RF transceiver 822 with the UE 104 and/or base station 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 350 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see the UE 350 of FIG. 3) and include the additional modules of the apparatus 802.

The communication manager 832 includes a redirection component 840 that is configured to receive a redirection command from a network, for example, as described in connection with 702 of FIG. 7.

The communication manager 832 also includes a TAU component 842 that is configured to initiate a TAU procedure when performing a change from a first cell associated with a first RAT to connect to a second cell associated with a second RAT, for example, as described in connection with 602 of FIGS. 6 and/or 704 of FIG. 7.

The communication manager 832 also includes a timer initiation component 844 that is configured to initiate a timer when the TAU procedure fails, for example, as described in connection with 604 of FIGS. 6 and/or 706 of FIG. 7.

The communication manager 832 also includes an event monitoring component 846 that is configured to monitor for a timer modification event, for example, as described in connection with 708 of FIG. 7. The example event monitoring component 846 may also be configured to determine whether a timer modification event occur before the timer expires, for example, as described in connection with 718 of FIG. 7.

The communication manager 832 also includes a measurement component 848 that is configured to measure a signal quality of a connection with the second cell, for example, as described in connection with 710 of FIG. 7. The example measurement component 848 may also be configured to determine that the measured signal quality satisfies a quality threshold, for example, as described in connection with 712 of FIG. 7.

The communication manager 832 also includes a reselection component 850 that is configured to perform a cell reselection procedure to establish a connection with a third cell using the second RAT, for example, as described in connection with 714 of FIG. 7. The example reselection component 850 may also be configured to determine that a connection is established with the third cell, for example, as described in connection with 716 of FIG. 7.

The communication manager 832 also includes a re-initiation component 852 that is configured to re-initiate the TAU procedure based on the occurrence of a timer modification event, for example, as described in connection with 606 of FIGS. 6 and/or 720 of FIG. 7. The example re-initiation component 852 may also be configured to re-initiate the TAU procedure after the first duration associated with the timer expires, for example, as described in connection with 724 of FIG. 7.

The communication manager 832 also includes a timer reset component 854 that is configured to reset the timer to the first duration when the re-initiating of the TAU procedure is successfully completed, for example, as described in connection with 722 of FIG. 7.

The apparatus may include additional components that perform each of the blocks of the algorithm in the aforementioned flowcharts of FIGS. 5, 6, and/or 7. As such, each block in the aforementioned flowcharts of FIGS. 5, 6, and/or 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 802 may include a variety of components configured for various functions. In one configuration, the apparatus 802, and in particular the cellular baseband processor 804, includes means for initiating a TAU procedure when performing a change from a first cell associated with a first RAT to connect to a second cell associated with a second RAT different than the first RAT. The example apparatus 802 also includes means for initiating a timer when the TAU procedure fails, the timer associated with a first duration. The example apparatus 802 also includes means for re-initiating the TAU procedure based on an occurrence of a timer modification event, the re-initiating of the TAU procedure occurring before the first duration associated with the timer expires.

In another configuration, the example apparatus 802 also includes means for measuring a signal quality of a connection with the second cell.

In another configuration, the example apparatus 802 also includes means for performing a cell reselection procedure to establish a connection with a third cell using the second RAT.

In another configuration, the example apparatus 802 also includes means for re-initiating the TAU procedure after the first duration associated with the timer expires.

In another configuration, the example apparatus 802 also includes means for resetting the timer to the first duration when the re-initiating of the TAU procedure is successfully completed.

The aforementioned means may be one or more of the aforementioned components of the apparatus 802 configured to perform the functions recited by the aforementioned means. As described supra, the apparatus 802 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means.

Aspects disclosed herein provide techniques for the UE to adjust the handling of the T3411 timer to improve the UE performance and call quality. For example, aspects disclosed herein enable the UE to reduce the T3411 timer duration or to ignore the T3411 timer if conditions at the UE change. In some examples, the UE may monitor for a timer modification event after initiating the T3411 timer. Examples of a timer modification event include an improved signal quality of a current cell. In some examples, the timer modification event may occur when the signal quality of the current cell satisfies (e.g., is greater than or equal to) a quality threshold. In other examples, the timer modification event may occur when the UE performs a cell reselection procedure and establishes a connection with another cell. In examples in which the UE detects the occurrence of a timer modification event, the UE may perform another TAU procedure without waiting for the T3411 timer to expire. That is, the occurrence of the timer modification event may trigger the UE to immediately re-initiate performing the TAU procedure. As the timer modification event is associated with an improved signal quality, the performing of the TAU procedure may be successful, which may reduce occurrences of call failures and, thus, improve call performance.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to initiate a TAU procedure when performing a change from a first cell associated with a first RAT to connect to a second cell associated with a second RAT different than the first RAT; initiate a timer when the TAU procedure fails, the timer associated with a first duration; and re-initiate the TAU procedure based on an occurrence of a timer modification event, the re-initiating of the TAU procedure occurring before the first duration associated with the timer expires.

Aspect 2 is the apparatus of aspect 1, further including that the memory and the at least one processor are configured to perform the change from the first cell to the second cell as part of an EPS fallback due to a VoNR call, a VOLTE call or a VT call.

Aspect 3 is the apparatus of any of aspects 1 and 2, further including that the memory and the at least one processor are configured to perform the change from the first cell to the second cell in response to receiving a redirection command from a network.

Aspect 4 is the apparatus of any of aspects 1 to 3, further including that the timer modification event comprises an increase in signal quality for the second cell.

Aspect 5 is the apparatus of any of aspects 1 to 4, further including that the memory and the at least one processor are further configured to: measure a signal quality of a connection with the second cell, and where the occurrence of the timer modification event comprises the measured signal quality satisfying a quality threshold.

Aspect 6 is the apparatus of any of aspects 1 to 5, further including that the memory and the at least one processor are further configured to: perform a cell reselection procedure to establish a connection with a third cell using the second RAT, and where the occurrence of the timer modification event comprises the performing of the cell reselection procedure.

Aspect 7 is the apparatus of any of aspects 1 to 6, further including that the memory and the at least one processor are further configured to: re-initiate the TAU procedure after the first duration associated with the timer expires.

Aspect 8 is the apparatus of any of aspects 1 to 7, further including that the memory and the at least one processor are further configured to: reset the timer to the first duration when the re-initiating of the TAU procedure is successfully completed.

Aspect 9 is the apparatus of any of aspects 1 to 8, further including a transceiver coupled to the at least one processor.

Aspect 10 is a method of wireless communication for implementing any of aspects 1 to 9.

Aspect 11 is an apparatus for wireless communication including means for implementing any of aspects 1 to 9.

Aspect 12 is a non-transitory computer-readable storage medium storing computer executable code, where the code, when executed, causes a processor to implement any of aspects 1 to 9.

What is claimed is:

1. An apparatus for wireless communication at a user equipment (UE), comprising:
a memory; and
at least one processor coupled to the memory and configured to:
initiate a tracking area update (TAU) procedure when performing a change from a first cell associated with a first radio access technology (RAT) to connect to a second cell associated with a second RAT different than the first RAT;
initiate a timer when the TAU procedure fails, the timer associated with a first duration; and
re-initiate the TAU procedure based on an occurrence of a timer modification event, the re-initiating of the TAU procedure occurring before the first duration associated with the timer expires.

2. The apparatus of claim 1, wherein the memory and the at least one processor are configured to perform the change from the first cell to the second cell as part of an evolved packet system (EPS) fallback due to a Voice over NR (VoNR) call, a Voice over Long-Term Evolution (VOLTE) call or a video telephony (VT) call.

3. The apparatus of claim 1, wherein the memory and the at least one processor are configured to perform the change from the first cell to the second cell in response to receiving a redirection command from a network.

4. The apparatus of claim 1, wherein the timer modification event comprises an increase in signal quality for the second cell.

5. The apparatus of claim 1, wherein the memory and the at least one processor are further configured to:
measure a signal quality of a connection with the second cell, and
wherein the occurrence of the timer modification event comprises the measured signal quality satisfying a quality threshold.

6. The apparatus of claim 1, wherein the memory and the at least one processor are further configured to:
perform a cell reselection procedure to establish a connection with a third cell using the second RAT, and
wherein the occurrence of the timer modification event comprises the performing of the cell reselection procedure.

7. The apparatus of claim 1, wherein the memory and the at least one processor are further configured to:
re-initiate the TAU procedure after the first duration associated with the timer expires.

8. The apparatus of claim 1, wherein the memory and the at least one processor are further configured to:
reset the timer to the first duration when the re-initiating of the TAU procedure is successfully completed.

9. The apparatus of claim 1, further comprising a transceiver coupled to the at least one processor.

10. A method of wireless communication at a user equipment (UE), comprising:
initiating a tracking area update (TAU) procedure when performing a change from a first cell associated with a first radio access technology (RAT) to connect to a second cell associated with a second RAT different than the first RAT;
initiating a timer when the TAU procedure fails, the timer associated with a first duration; and
re-initiating the TAU procedure based on an occurrence of a timer modification event, the re-initiating of the TAU procedure occurring before the first duration associated with the timer expires.

11. The method of claim 10, wherein the UE performs the change from the first cell to the second cell as part of an evolved packet system (EPS) fallback due to a Voice over NR (VoNR) call, a Voice over Long-Term Evolution (VOLTE) call or a video telephony (VT) call.

12. The method of claim 10, wherein the UE performs the change from the first cell to the second cell in response to receiving a redirection command from a network.

13. The method of claim 10, wherein the timer modification event comprises an increase in signal quality for the second cell.

14. The method of claim 10, further comprising:
measuring a signal quality of a connection with the second cell, and
wherein the occurrence of the timer modification event comprises the measured signal quality satisfying a quality threshold.

15. The method of claim 10, further comprising:
performing a cell reselection procedure to establish a connection with a third cell using the second RAT, and
wherein the occurrence of the timer modification event comprises the performing of the cell reselection procedure.

16. The method of claim 10, further comprising:
re-initiating the TAU procedure after the first duration associated with the timer expires.

17. The method of claim 10, further comprising:
resetting the timer to the first duration when the re-initiating of the TAU procedure is successfully completed.

18. An apparatus for wireless communication at a user equipment (UE), comprising:
means for initiating a tracking area update (TAU) procedure when performing a change from a first cell associated with a first radio access technology (RAT) to connect to a second cell associated with a second RAT different than the first RAT;
means for initiating a timer when the TAU procedure fails, the timer associated with a first duration; and
means for re-initiating the TAU procedure based on an occurrence of a timer modification event, the re-initiating of the TAU procedure occurring before the first duration associated with the timer expires.

19. The apparatus of claim 18, further comprising:
means for receiving a redirection command from a network, and
wherein the UE performs the change from the first cell to the second cell in response to receiving the redirection command.

20. The apparatus of claim 18, wherein the timer modification event comprises an increase in signal quality for the second cell.

21. The apparatus of claim 18, further comprising:
means for measuring a signal quality of a connection with the second cell, and
wherein the occurrence of the timer modification event comprises the measured signal quality satisfying a quality threshold.

22. The apparatus of claim 18, further comprising:
means for performing a cell reselection procedure to establish a connection with a third cell using the second RAT, and
wherein the occurrence of the timer modification event comprises the performing of the cell reselection procedure.

23. The apparatus of claim 18, further comprising:
means for re-initiating the TAU procedure after the first duration associated with the timer expires.

24. The apparatus of claim 18, further comprising:
means for resetting the timer to the first duration when the re-initiating of the TAU procedure is successfully completed.

25. The apparatus of claim 18, further comprising a transceiver.

26. A computer-readable medium storing computer executable code at a user equipment (UE), the code, when executed, causes a processor to:
initiate a tracking area update (TAU) procedure when performing a change from a first cell associated with a first radio access technology (RAT) to connect to a second cell associated with a second RAT different than the first RAT;
initiate a timer when the TAU procedure fails, the timer associated with a first duration; and
re-initiate the TAU procedure based on an occurrence of a timer modification event, the re-initiating of the TAU procedure occurring before the first duration associated with the timer expires.

27. The computer-readable medium of claim 26, wherein the code, when executed, causes the processor to:
measure a signal quality of a connection with the second cell, and
wherein the occurrence of the timer modification event comprises the measured signal quality satisfying a quality threshold.

28. The computer-readable medium of claim 26, wherein the code, when executed, causes the processor to:
perform a cell reselection procedure to establish a connection with a third cell using the second RAT, and
wherein the occurrence of the timer modification event comprises the performing of the cell reselection procedure.

29. The computer-readable medium of claim 26, wherein the code, when executed, causes the processor to:
re-initiate the TAU procedure after the first duration associated with the timer expires.

30. The computer-readable medium of claim 26, wherein the code, when executed, causes the processor to:
reset the timer to the first duration when the re-initiating of the TAU procedure is successfully completed.
